(19) United States
(12) Patent Application Publication
(10) Pub. No.: US 2012/0169539 A1
(43) Pub. Date: Jul. 5, 2012

(54) ROBUST BEAMFORMING FOR ANTENNA ARRAYS THROUGH USE OF MOTION/DISPLACEMENT SENSING

(76) Inventors: Howard C. Huang, New York, NY (US); Cuong Tran, Howell, NJ (US)

(21) Appl. No.: 12/984,916

(22) Filed: Jan. 5, 2011

(51) Int. Cl. H01Q 3/00

(52) U.S. Cl. 342/372

(57) ABSTRACT

One embodiment of a beamforming system includes an antenna array and at least one sensor configured to sense one of movement and displacement of at least a portion of the antenna array. A processor is configured to control beamforming by the antenna array based on output from the sensor.

### BACKGROUND OF THE INVENTION

Digital beamforming using an array of antenna elements is an effective way to increase the coverage and throughput of wireless networks. For a given configuration of antenna array elements, digital beamforming weights (complex amplitude weights) can be designed to achieve desired design characteristics including beamwidth, beam direction, and sidelobe levels. However, if the position or orientation of an antenna element is changed, the resulting beam shape will be changed, resulting in degraded performance.

### SUMMARY OF THE INVENTION

The present invention relates to improving beamforming of an antenna array.

One embodiment of a beamforming system includes an antenna array and at least one sensor configured to sense one of movement and displacement of at least a portion of the antenna array. A processor is configured to control beamforming by the antenna array based on output from the sensor.

For example, the sensor may be connected to a support supporting antenna elements of the antenna array. As another example, the antenna array includes a plurality of antenna elements, and each of a plurality of sensors is associated with a different one of the antenna elements. Here, the processor is configured to control beamforming by the antenna array based on output from the plurality of sensors.

One embodiment of a method for controlling beamforming of an antenna array includes measuring, using at least one sensor, at least one of movement and displacement of at least a portion of an antenna array. Beamforming by the antenna array is controlled based on output from the sensor.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIGS. 1-3 illustrate sensor architectures according to example embodiments; and

FIG. 4 illustrates a system configured to update and generate beamforming weights based on detected motion and/or displacement of antenna elements.

### DETAILED DESCRIPTION OF THE EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In the following description, for purposes of explanation and not limitation, specific details are set forth such as particular architectures, interfaces, techniques, etc., in order to provide a thorough understanding of the present invention. However, it will be apparent to those skilled in the art that the present invention may be practiced in other illustrative embodiments that depart from these specific details. In some instances, detailed descriptions of well-known devices, circuits, and methods are omitted so as not to obscure the description of the present invention with unnecessary detail. All principles, aspects, and embodiments of the present invention, as well as specific examples thereof, are intended to encompass both structural and functional equivalents thereof. Additionally, it is intended that such equivalents include both currently known equivalents as well as equivalents developed in the future.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types. The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits, field programmable gate arrays (FPGAs) computers or the like.

Portions of the embodiments and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a flash memory, a floppy disk, a hard drive, etc.) or optical (e.g., a compact disk read only memory or “CD ROM”, DVD, Blu-Ray, etc.), and may be read only or random access. Similarly, the transmission medium may be an air interface, twisted wire pairs, coaxial cable, optical fiber, or some other suitable transmission medium known to the art. The embodiments are not limited by these aspects of any given implementation.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The embodiments will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples. Where applicable, the words and phrases used herein should be understood and interpreted to have a meaning consistent with the understanding of those words and phrases by those skilled in the relevant art.

In example embodiments of the present invention, sensors are used to track the relative (or absolute) position and orientation of each element or of the support (e.g., a frame) on which the elements are attached. These sensors may be low-cost, high-performance accelerometers or gyroscopes that measure movement or rotation in three dimensions. Electronic compasses may also be used to measure absolute azimuth orientation. Still further, the sensors may be any sensor for detecting an amount of motion and/or displacement. The sensor or sensors may be calibrated in a controlled environment (for example, at the manufacturing facility).

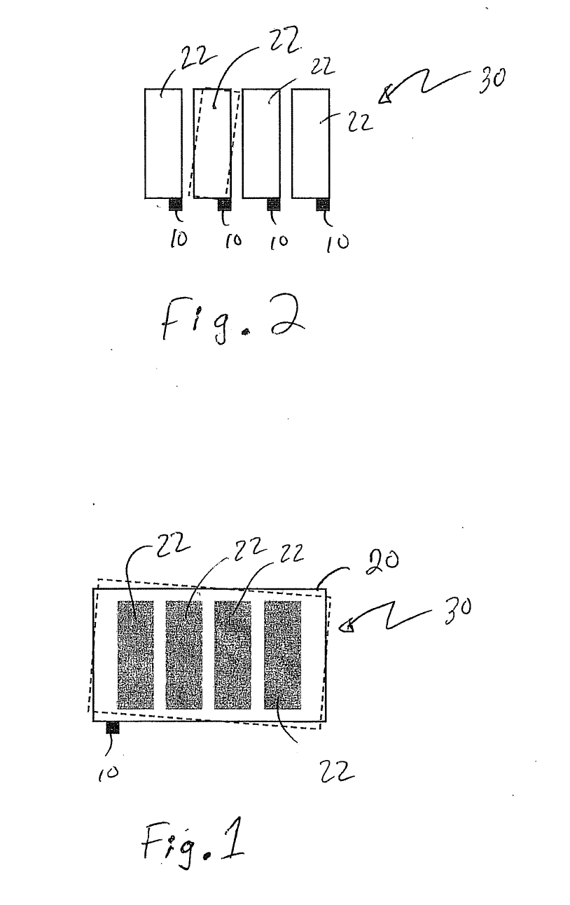

FIG. 1 illustrates an example embodiment of a sensor architecture. In this example, a sensor 10 is attached to the support (e.g., an array frame) 20 of an array 30. The array frame 20 supports a plurality of antenna elements 22. The sensor 10 may be calibrated in a controlled environment to create an absolute vertical reference and an absolute rotational (azimuth) reference. When the array 30 is initially installed in the field, the array 30 may be adjusted so that the tilt and pointing direction, measured with respect to the absolute references, match the parameters set by the deployment engineers. During operation, beamforming weights for the antenna elements 22 may be computed to conform to this set of nominal array parameters. At this point, the sensor 10 may be calibrated so that any changes in position are detected with respect to this nominal position. Also, the beamforming weights may be updated to account for these changes. This will be described in more detail below with respect to FIG. 4.

FIG. 2 illustrates another example embodiment of a sensor architecture. In this example, a sensor 10 is attached to each antenna element 22. In FIG. 2, the frame 20 has not been shown for the sake of clarity, and it will be understood that a single frame 20 for multiple antenna elements 22 may be provided, or alternatively, a support for each antenna element 22 may be provided. In this case, beamforming weights for each antenna element 22 may be updated to compensate for movement or displacement of each element 22 based on output from the sensor 10 associated with that antenna element 22.

As a further embodiment, the embodiments of FIGS. 1 and 2 may be combined, and sensors 10 may be placed on individual antenna elements 22 and the array frame 20 for redundancy.

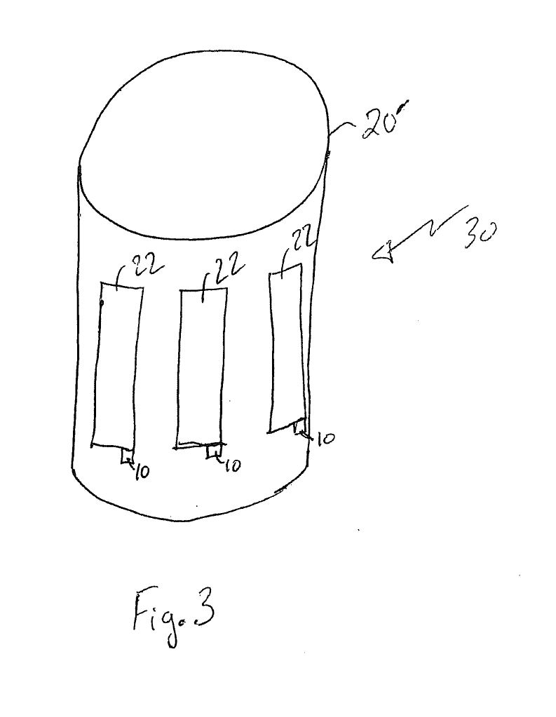

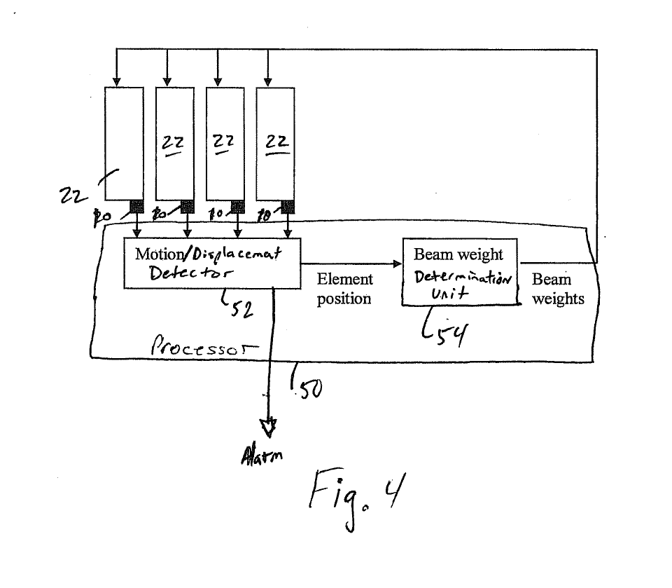

In the embodiments of FIGS. 1 and 2, example architectures for four antenna elements 22 were shown. However, the present invention is not limited to these examples, and may be applied to arrays with any number of antenna elements. Still further, while a planar array is shown, the present invention is not limited to this configuration. Instead, the present invention is applicable to any antenna configuration. As an example, the antenna frame 20′ may be cylindrical, with antenna elements 22 disposed along the lateral surface of the cylindrical frame 20′ as shown in FIG. 3.

FIG. 4 illustrates a system configured to update and generate beamforming weights based on detected motion and/or displacement of antenna elements. The system of FIG. 4 is illustrated in combination with the antenna array of FIG. 2, but it will be understood that the system is not limited to this application and may be combined with any antenna array according to the present invention.

As shown, a processor 50 such as a digital signal processor may include a motion and/or displacement detector 52 and a beam weight determination unit 54. Based output from the sensor or sensors 10, the motion and/or displacement detector 52 determines an amount of movement and/or an amount of displacement, if any, for the antenna elements 22. Alternatively, based on output from the sensors 10, the detector 52 indicates the current position of each antenna element. The beam weight determination unit 54 modifies, adjusts and/or updates beam weights for the antenna elements 22 based on the output from the detector 52.

For example, given an array of M antenna elements 22, we want to transmit a data signal s in the direction θ by applying a complex amplitude shift to each antenna element 22. This well-known technique is known as precoding. The precoded baseband signal transmitted from antenna i (i=, . . . , M) is gi(θ)s, where gi(θ) is the precoding weight (a complex-valued scalar) for the ith antenna as a function of the desired direction θ, and s is the complex-valued data symbol common to all transmit antennas. Namely, the precoding weights gi(θ) are the beam weights. We let g(θ) be the M-dimensional precoding vector whose ith element (i=1, . . . , M) is gi(θ). The precoding vector depends on θ and on the position of the antenna elements. Letting (Ri,Bi) be the polar coordinates of antenna element i relative to an arbitrary origin (Ri is the distance from the origin, and Bi is the angle), the vector g(θ) is a function of θ and (Ri,Bi) (i=, . . . , M). Therefore, if one or more elements are displaced, the vector g(θ) can be recomputed using the updated location of the displaced element(s). If the antenna elements are directional (i.e., not omni-directional), then each element could be characterized by an additional parameter giving its angular orientation.

As a more specific example, consider an array with omni-directional elements where the precoding weights correspond to the maximal ratio transmitter for a line-of-sight channel. For a signal arriving from direction θ, the complex amplitude at element i is:

h exp[(−2πj/λ)Rᵢ cos(Bᵢ−θ)]

where h is the complex amplitude at the origin, λ is the signal wavelength, and j is the square-root of negative 1. The complex amplitude of the precoding weight corresponding to the maximal ratio transmitter is simply the complex conjugate of the relative phase offset with respect to the origin:

$${g}_{i} ( θ ) = \frac{1}{\sqrt{M}} exp [ ( 2 π j / λ ) {R}_{i} cos ( {B}_{i} - θ ) ] .$$

The weight is normalized so that the precoding vector has unit norm: ∥g(θ)∥²=1. The precoding weight can be updated according to this expression to account for the position of antenna element i.

In one embodiment, the sensors 10 and the detector 52 cooperatively determine the current position in polar coordinates for each antenna element 22, and the beam weight determination unit 54 uses this output to continually recompute the beam weights. Instead of continually recomputing beam weights, the detector 52 may also detect when the position of an antenna element 22 changes and trigger recomputing only when a change is detected.

A sensor 10 and the detector 52 may cooperatively determine the current position of an antenna element 22 in several ways. For example, the sensor 10 may be configured to determine the absolute position of the antenna element 22. The detector 22 may compare this to a position of the antenna element stored in memory in or associated with the processor 50 to determine if a change has occurred. Alternatively, the sensor 10 may indicate an amount of change in position. The detector 52 may combine this detected change with the stored position to determine the new, current position of the antenna element. This new current position for the antenna element may then be stored. It will be appreciated that numerous other methods of determining a change position and/or the position of an antenna element may exist and be used.

Accordingly, in example embodiments, motion or displacement of antenna elements is detected by a sensor or sensors, and the antenna element positions are updated. The beamforming weights for the antenna elements are then updated to compensate for the displaced element(s).

Additionally, in the case where the displacement exceeds a given threshold, an alarm may be sent to the operator so the antenna element or array can be physically adjusted.

The present invention makes the beamforming robust to intentional or unintentional changes in the element positions or orientations. Intentional changes could occur, for example, if the operator physically steers the array to different directions at different times of the day to address changing traffic needs. While the mechanical structure should be reliable, the present invention provides additional reliability in the beamforming. Unintentional changes could occur as a result of inclement weather or defects in the physical structure.

The invention being thus described, it will be obvious that the same may be varied in many ways. Such variations are not to be regarded as a departure from the invention, and all such modifications are intended to be included within the scope of the invention.

We claim:

1. A beamforming system, comprising:
an antenna array;
at least one sensor configured to sense one of movement and displacement of at least a portion of the antenna array; and
a processor configured to control beamforming by the antenna array based on output from the sensor.

2. The beamforming system of claim 1, wherein the sensor is connected to a support supporting antenna elements of the antenna array.

3. The beamforming system of claim 1, wherein
the antenna array includes a plurality of antenna elements;
each of a plurality of sensors is associated with a different one of the antenna elements, each of the plurality of sensors is configured to sense one of movement and displacement of the associated antenna element; and
the processor is configured to control beamforming by the antenna array based on output from the plurality of sensors.

4. The beamforming system of claim 1, wherein the sensor is one of an accelerometer, a gyroscope, and an electronic compass.

5. The beamforming system of claim 1, wherein the sensor is cooperatively coupled to the antenna array to sense undesired movement or displacement of the antenna array.

6. The beamforming system of claim 5, wherein the processor is configured to compensate for the undesired movement or displacement of the antenna array based on output from the sensor in controlling the beamforming.

7. The beamforming system of claim 1, wherein the sensor is cooperatively coupled to an antenna element of the antenna array to sense undesired movement of the antenna element.

8. The beamforming system of claim 7, wherein the processor is configured to compensate for the undesired movement or displacement of the antenna element based on output from the sensor in controlling the beamforming.

9. The beamforming system of claim 1, wherein the processor is configured to output a warning if the detected movement or displacement exceeds a threshold.

10. A method for controlling beamforming of an antenna array, comprising:
measuring, using at least one sensor, at least one of movement and displacement of at least a portion of an antenna array;
controlling beamforming by the antenna array based on output from the sensor.
